(19) United States
(12) Patent Application Publication
(10) Pub. No.: US 2009/0316732 A1
(43) Pub. Date: Dec. 24, 2009

(54) FIBER OPTIC POWER LASER DEVICE

(75) Inventors: Philippe Metivier, Corenc (FR); Francois Salin, Gradigan (FR)

Correspondence Address: YOUNG & THOMPSON, 209 Madison Street, Suite 500, Alexandria, VA, 22314, US

(73) Assignee: EOLITE SYSTEMS, Pessac (FR)

(21) Appl. No.: 12/373,615

(22) PCT Filed: Jun. 8, 2007
(86) PCT No.: PCT/FR07/51397

§ 371 Date: Jan. 13, 2009

(30) Foreign Application Priority Data
Jul. 13, 2006 (FR) 0652973

(51) Int. Cl. H01S 3/067; H01S 3/091

(52) U.S. Cl. 372/6; 372/70

(57) ABSTRACT

A power fibre laser device includes a power laser diode emitting a pump wave, an optical resonator including fully reflective and partially reflective ends, an amplifying multimode optical fibre, and an optical element coupling the pump wave in the multimode optical fibre. The optical resonator includes at least one submodule consisting of a spatial filtering element and including an optical element having a definite position in the optical submodule so as to enable the optical submodule to reproduce, after a round trip of the laser beam, the amplitude and phase of the fundamental mode of the multimode optical fibre to the input or output face of the multimode optical fibre, whereby minimising losses in the fundamental mode, and enabling the optical submodule to filter the other modes, producing additional losses in the modes in the optical resonator, whereby minimising the number of laser modes that propagate in the optical resonator.

The invention relates to a power fibre laser device operating to produce a spatially single-mode radiation from a multimode optical fibre.

By single-mode radiation, we mean a radiation whose divergence is close to the minimum imposed by the diffraction of the intensity profile of said radiation.

Solid-state lasers consist of at least one amplifying medium and an optical resonator formed by a set of mirrors. The spatial properties of the output beam are given by the characteristics of this resonator.

In particular, it can be shown that, if the resonator is said stable, the shape of the beam can be resolved according to Hermite-Gauss functions. These functions are called modes of the cavity.

Among these modes, the fundamental mode has a Gaussian shape and has the smallest divergence. It is often singled out by the user because it enables the smallest focusing. Nevertheless, the excited region in the amplifying medium has an inherent size that depends only on the way the energy is distributed in the medium and does not depend at all on the resonator.

When this excited region is wider than the diameter of the fundamental mode at this place of the cavity, a part of the energy is coupled to higher order modes and the produced beam becomes multimode. The high order modes have a greater divergence and thus focus on a region of greater diameter. This phenomenon can also be explained considering that any mode gets a certain gain in the amplifying medium and undergoes losses by propagation.

Only the modes whose gain exceeds losses can produce a laser effect. The gain of a mode depends on the overlap of this mode and of the excited region in the amplifying medium.

On the whole, to make the laser spatially single-mode, it is advisable to design the resonator so as to obtain the best match between the size of the fundamental mode and that of the excited region.

If this is not possible, for example because of the resonator length, the single-mode operation of the resonator can be forced by providing an aperture, the diameter of which is calculated so as to match exactly with that of the fundamental mode at the aperture. The losses undergone by the high order modes when they pass through the hole are great enough to bring the latter under the laser effect threshold and permit a laser effect only for the fundamental mode.

Fibre lasers are distinct from conventional solid-state lasers in that the amplifying medium has a guiding structure that imposes some spatial characteristics to the beam passing through it.

Thus, some fibres permit only the guidance of single-mode beam, whereas others allow several modes. Including such a fibre in an optical resonator gives a fibre laser, the spatial characteristics of which are generally imposed by the fibre. In particular, if the fibre is single-mode, the laser can only be single-mode.

This particular case is very advantageous, but it is not always implementable. In particular, the number of modes supported by the fibre is a function of the fibre core diameter and of the index difference between the core and the sheath.

In order for the propagation to be kept purely single-mode when the core diameter increases, the index step between the core and the sheath has to be reduced. The fibre manufacturing technology does not presently allow obtaining single-mode fibres having a core diameter greater than about 20 micrometres. Given the damage threshold of the silica or glass of which is formed the core of these fibres, it is thus impossible to exceed certain average-power limits in case of continuous lasers or peak-power limits in case of pulsed lasers.

To increase the reachable power, it is necessary to accept a certain spatial quality loss and to use multimode fibres. A solution has been found, which uses so-called “photonic fibres” or “photonic-layer fibres” or MPF (“Multiclad Photonic Fibres”), the actual index of which can be modulated through introduction of air-filled capillary in the sheath.

Such fibres are described in the articles from J. Limpert, N. Deguil-Robin, I. Manek-Hönninger, F. Salin, F. Röser, A. Liem, T. Schreiber, S. Nolte, H. Zellmer, A. Tünnermann, J. Broeng, A. Petersson, and C. Jakobsen, “High-power rod-type photonic crystal fibre laser,” Opt. Express 13, 1055-1058 (2005). MPF lasers comprise optical amplifiers having a glass fibre formed with a doped core and at least one peripheral sheath which operates to guide the produced wave. The core is doped with a rare earth ion, in general Neodymium or Ytterbium. The guidance is ensured through a photonic structure formed of a geometric set of air channels or capillaries (holes). This structure artificially lowers the index met by the produced wave and allows single-mode propagations. Thus, it is possible to obtain single-mode fibres having a diameter greater than 60 micrometres.

Nevertheless, these fibres are complicated to manufacture and require the core index to be perfectly controlled and uniform. This is not compatible with strong doping, and a compromise has yet to be accepted between core diameter and doping uniformity.

In particular, the fibre core itself can be microstructured so as to guarantee a perfectly controlled average index. To this end, glass or air non-doped regions are introduced in the core. The relative surface area of these regions offers an almost-perfect control of the index, but imposes a locally very high doping to ensure sufficient core absorption at the used wavelength to excite the amplifying medium.

Over time, these over-concentrations give rise to undesirable secondary effects.

The document US200543409 has shown that it is possible to excite the fundamental mode of a multimode fibre by perfectly adjusting the characteristics of a beam incident on the input face of the fibre.

This technique has been used in an amplifier with injection of an external source to the input face of the multimode fibre. This selective injection method needs an external signal having a perfectly Gaussian beam and, consequently, it does not apply to an oscillator.

It is also known that any bending or position variation of the fibre tends to couple a part of the radiation from this mode to high order modes, which makes the radiation multimode at the output of the fibre, but it can also couples all or part of the multimode radiation to the sheath, so introducing losses in these higher order modes.

The document U.S. Pat. No. 6,496,301 has shown that a strong bending of the optical fibre can lead to a filtering of the higher order modes.

Nevertheless, this method inevitably entails losses in the fundamental mode and the implementation thereof on short fibres is difficult because it necessitates a multiturn winding having a diameter comprised between 5 and 15 cm, which corresponds to fibre lengths greater than 1 m.

Besides, the presence of several modes in the radiation issuing from the fibre makes it difficult or even impossible to obtain a polarized radiation.

For the moment, there is no suitable solution for fibre lasers that enables a single mode having a large transverse size to be obtained without risk for the fibre longevity.

The object of the invention is thus to provide a power fibre laser device intended for producing with a very good yield a stable single-mode radiation in the fundamental mode from a multimode fibre having an arbitrarily large diameter, without risk for the fibre longevity.

To that end, the invention relates to a power fibre laser device comprising:
a power laser diode emitting a pump wave,
an optical resonator comprising:
   a fully reflective end and a partially reflective end,
   an amplifying multimode optical fibre having a core with a diameter greater than 20 μm, as well as an input face and an output face at the ends thereof, said optical resonator comprising at least one submodule, said submodule being formed between the input face of the multimode optical fibre and the fully reflective end or between the output face of the multimode optical fibre and the partially reflective end,
optical coupling means that couple said pump wave in the multimode optical fibre so as to produce a laser beam in the optical resonator, a part of said laser beam being transmitted outside the optical resonator through the partially reflective end and another part of said laser beam being reflected inside the optical resonator,

According to the invention, the optical submodule 25, 26 is a spatial filtering means comprising optical means 2, 8 having a definite position in the optical submodule 25, 26 so as to make the optical submodule able to reproduce, after a round trip of the laser beam in this latter, the amplitude and phase of the fundamental mode of the multimode optical fibre 7 onto the input or output face 23, 24 of said multimode optical fibre 7, whereby minimising losses in the fundamental mode, and so as to make the optical submodule able to filter the other modes, producing additional losses in said other modes in the optical resonator, whereby minimising the number of laser modes that propagate in the optical resonator.

In different possible embodiments, the present invention also relates to the characteristics that will appear from the following description and that can be taken individually or according to any technically possible combination thereof:
the optical resonator comprises two submodules, arranged at each end of the multimode optical fibre,
the optical resonator comprises only one optical submodule, arranged at one end of the multimode optical fibre, the optical resonator being closed at the other end thereof by an optical closure means,
the optical closure means closing the optical resonator consists of one of the input or output faces of the multimode optical fibre, said input or output face being planar and perpendicular to the optical axis of the optical fibre,
the optical closure means closing the optical resonator consists of a single optical element having both convergence and reflection properties for a light wave,
the optical means of an optical submodule comprise one or more lenses associated with one of the reflective ends,
the optical means of an optical submodule comprise the input or output face of the multimode optical fibre, said input or output face having an inherent convergence that takes part in the filtering function,
the optical means of an optical submodule comprise a single-mode fibre tip in contact with one of the input and output faces of the multimode optical fibre, the laser beam being focused on said single-mode fibre tip by a lens,
the core of the multimode optical fibre has a non-uniform radial doping profile so as to favour the gain of the fundamental mode,
the multimode optical fibre comprises inherent filtering means so as to be slightly multimode,
the multimode optical fibre is mechanically stiffened by a stabilizing means,
the stabilizing means of the multimode optical fibre consists of a large-diameter mechanical sheath surrounding said multimode optical fibre,
the stabilizing means of the multimode optical fibre consists of a cylindrical support, in the periphery of which is hollowed-out a groove, in an helical manner, said multimode optical fibre being inserted in said groove so as to be tension-locked,
the stabilizing means of the multimode optical fibre consists of a linear support having a hollowed-out groove in which the multimode optical fibre is inserted along a longitudinal axis, said multimode optical fibre being covered with a second piece so as to be pressure-locked,
the optical resonator comprises an optical trigger arranged close to one of the reflective ends, enabling the optical resonator to generates laser pulses,
the power fibre laser device comprises one or more polarizing optical means.

The invention also relates to a power fibre laser system comprising a power fibre laser device as above described.

According to the invention, the power fibre laser system comprises a double-sheath amplifying multimode optical fibre, the light signal transmitted by the partially reflective end of the optical resonator being coupled to one of the faces of the amplifying multimode optical fibre, so as to excite only or almost only the fundamental mode of the double-sheath amplifying multimode optical fibre.

The invention will be more fully described with reference to the appended drawings, in which:

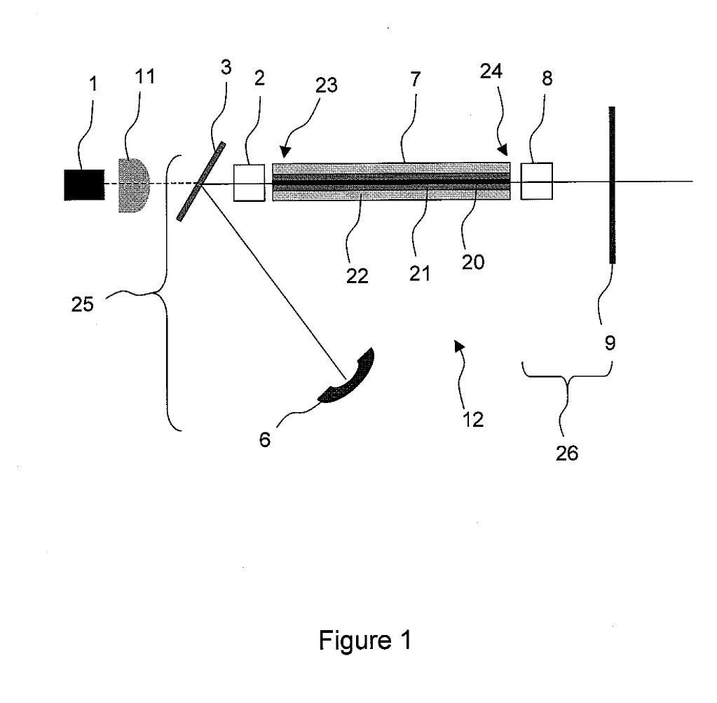

FIG. 1 shows a power fibre laser device according to an embodiment of the invention;

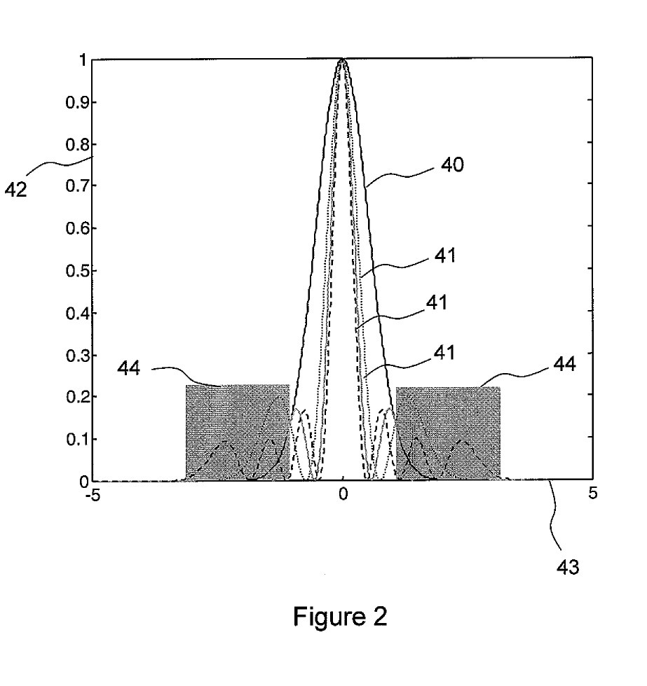

FIG. 2 shows the spatial distribution of the natural modes of an optical fibre;

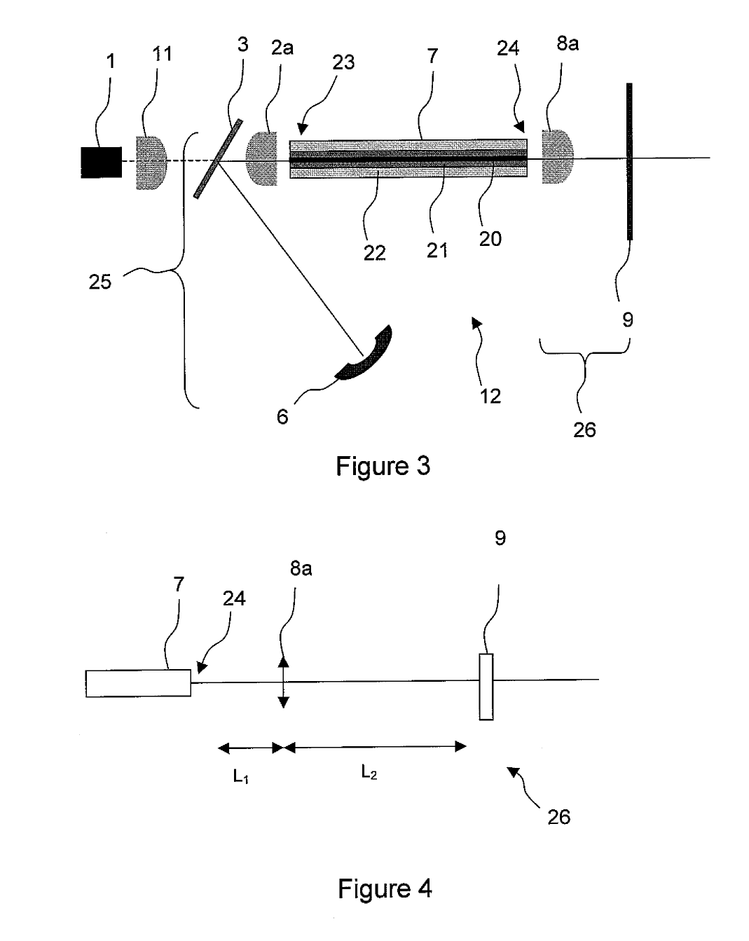

FIG. 3 shows a power fibre laser device comprising two optical submodules each comprising a lens and a fully or partially reflective mirror;

FIG. 4 shows the approximate distances between the optical elements so as to fulfill the filtering conditions;

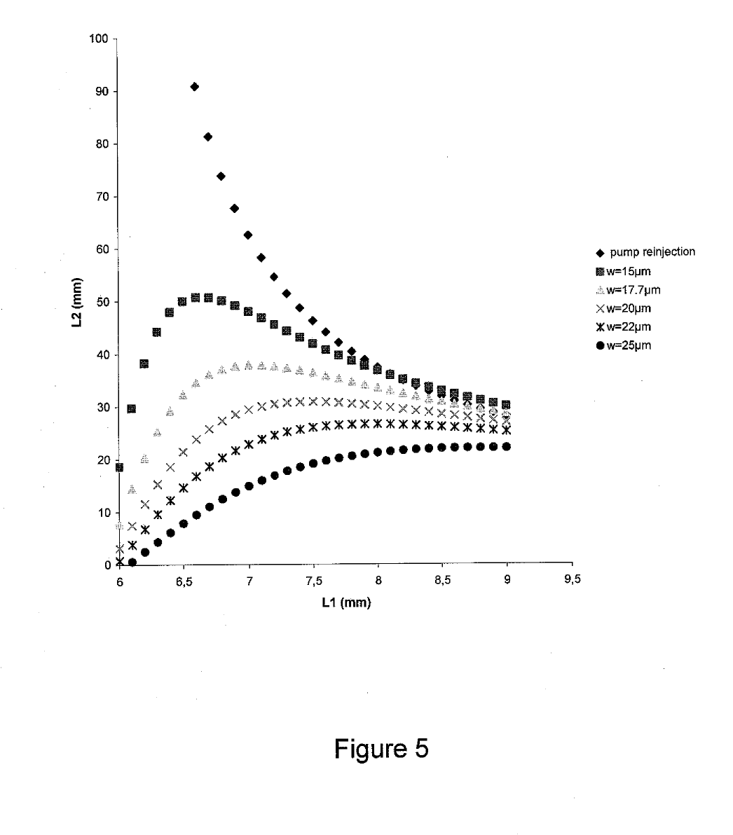

FIG. 5 shows couples L1-L2 for which the second submodule 26 resonates in the fundamental mode, for different size values w;

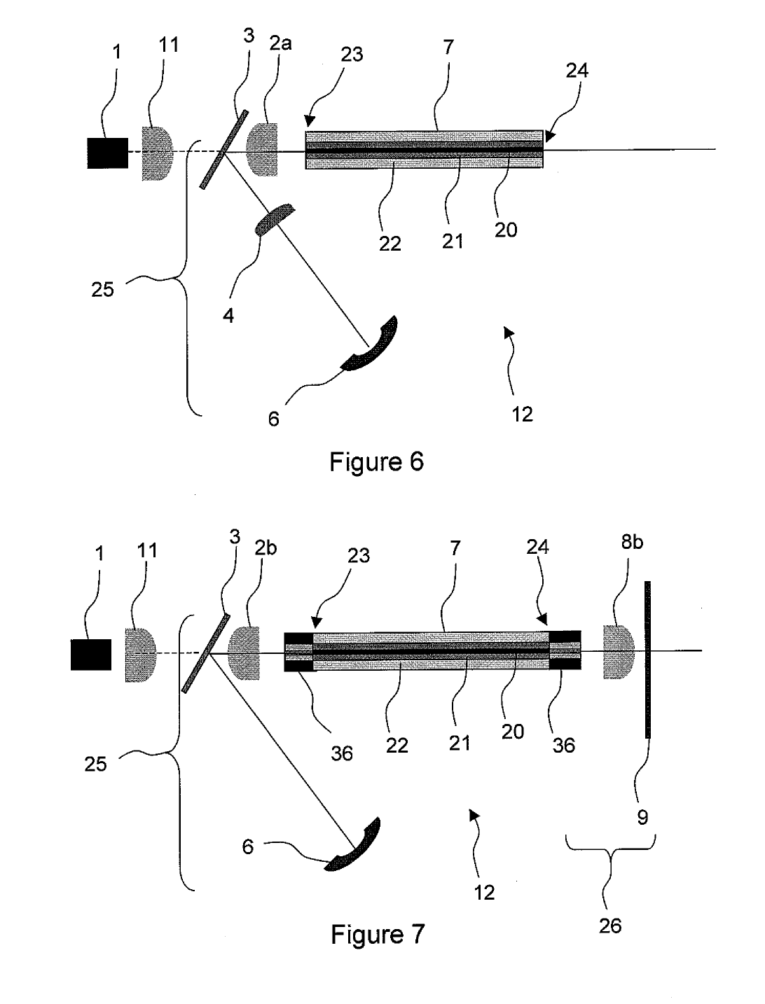

FIG. 6 shows a power fibre laser device comprising only one submodule according to another embodiment of the invention;

FIG. 7 shows a power fibre laser device comprising two single-mode fibre tips according to another embodiment of the invention;

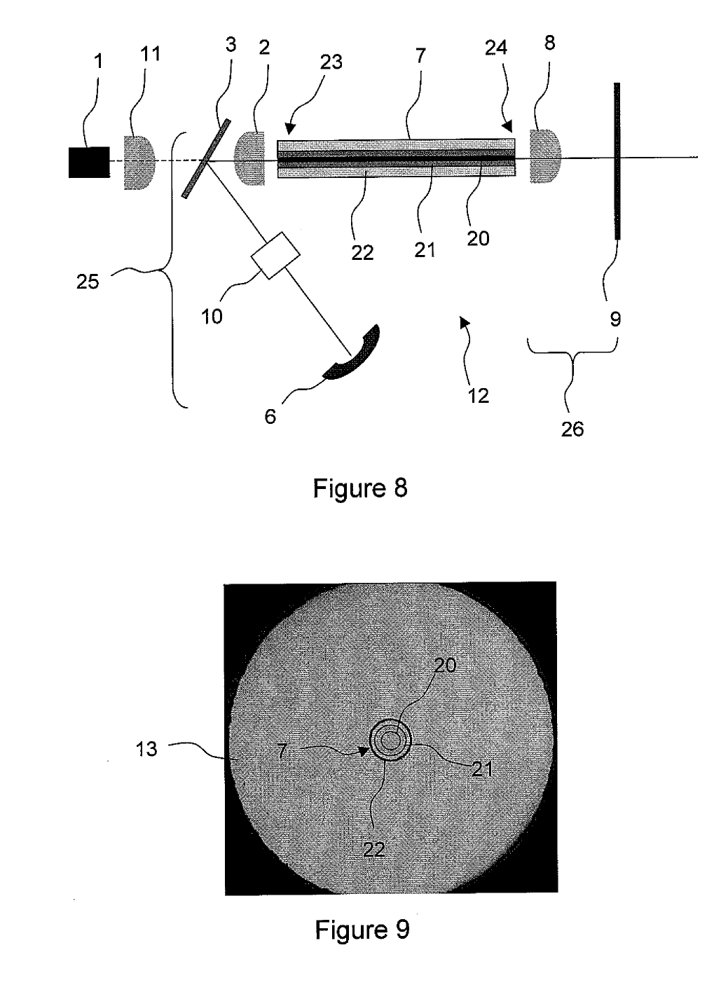

FIG. 8 shows a power fibre laser device comprising a trigger according to another embodiment of the invention;

FIG. 9 shows a cross-section of a multimode optical fibre surrounded by a mechanical sheath;

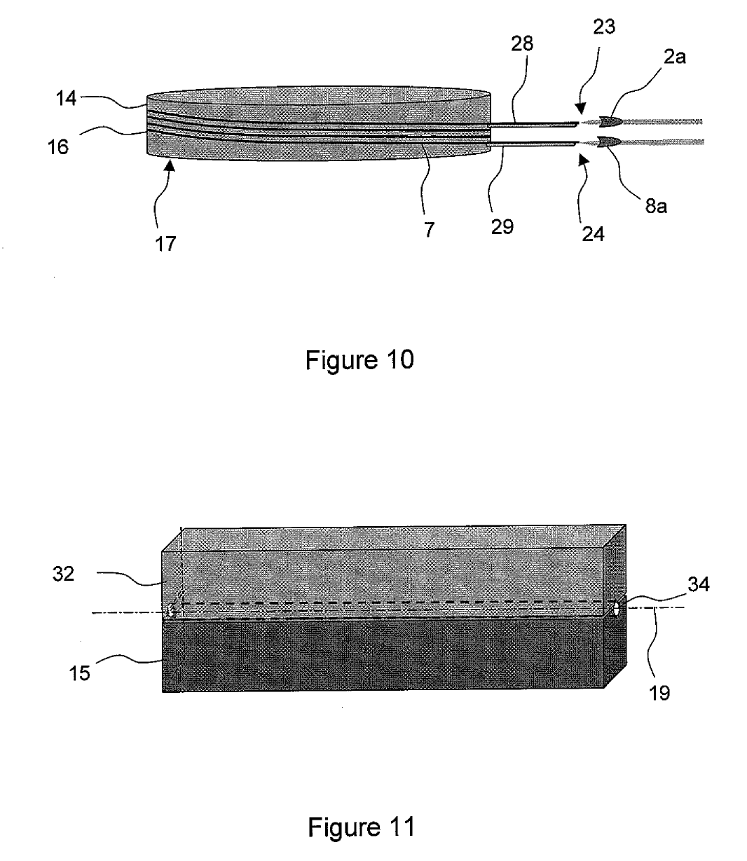

FIG. 10 shows a cylinder-shaped stabilizing means of the multimode optical fibre;

FIG. 11 shows a linear support operating to stabilize the multimode optical fibre.

FIG. 1 shows a power fibre laser device according to one of the embodiments of the invention.

This device comprises a power laser diode 1 emitting at least one pump wave. This power laser diode 1 can possibly be fibred.

The power fibre laser device also comprises an optical resonator 12, also called “cavity”, comprising a fully reflective end 6 and a partially reflective end 9.

By fully reflective end 6, we mean a fully or almost fully reflective end.

The ends 6 and 9 can be mirrors or diffraction gratings tuned on the laser emission wavelength. The partially reflective end 9 is able to transmit a part of the laser beam outside the optical resonator 12 and to reflect another part of the laser beam inside the optical resonator 12. The ends 6 and 9 reflect the beam at the laser emission wavelength.

The optical resonator 12 comprises an amplifying multimode optical fibre 7. This multimode optical fibre 7 is a double-sheath fibre consisting of a core 20 made of silica or glass doped with rare earth ions, such as ytterbium, neodymium, thulium or erbium.

The typical diameter of this core 20 is comprised between 20 and 100 micrometers, although greater diameters are possible.

This core 20 is surrounded by a first sheath 21, called “pumping sheath”, having a diameter typically comprised between 100 and 800 micrometers.

This second pumping sheath 21 is surrounded by a confining sheath 22, the index of which is distinctly lower than that of the pumping sheath 21. The confining sheath 22 can consist of a set of air-filled capillaries, a low-index polymer or any other non-absorbent material.

This confining sheath 22 can be surrounded by a mechanical sheath 13 providing the mechanical holding of the fibre. The multimode optical fibre 7 can be intrinsically stiff (diameter>1 mm) or flexible.

The power laser diode 1 has a wavelength adjusted to correspond to an absorption band of the doping agents of the core 20. It injects a pump wave into the core 20 of the multimode optical fibre 7.

Optical means 3, 11 operates to couple the pump wave in the multimode optical fibre 7, which produces in the latter a laser beam having a fundamental mode and having possibly higher order modes.

This pump radiation creates in the core 20 an excited population and thus an optical gain.

The length of the multimode optical fibre 7 is chosen to ensure a sufficient absorption of the pump wave and a cavity gain permitting the laser emission.

The multimode optical fibre 7 has an input face 23 and an output face 24 positioned at the ends thereof. The pump wave is injected through the input face 23 which is located close to the laser diode 1. The output face 24 is located close to the partially reflective end 9.

The optical resonator 12 comprises at least one submodule 25, 26.

In an embodiment of the invention, the optical resonator 12 comprises two optical submodules 25, 26, as described in FIG. 1.

It comprises a first optical submodule 25 formed between the fully reflective end 6 and the input face 23 of the multimode optical fibre 7, and a second optical submodule 26 formed between the partially reflective end 9 and the output face 24 of the multimode optical fibre 7.

An index-step fibre can be characterized by a parameter called “reduced frequency”, V, given by:

$$V = \frac{2 π a}{λ} NA$$

where:

a: radius of the fibre core

λ: laser wavelength

NA: numerical aperture of the fibre core

and,

NA=\sqrt{n₁²−n₂²}

where:

n₁: index of the fibre core

n₂: index of the pump sheath

The number of modes supported by a multimode fibre is given by:

$$M = \frac{1}{2} {( \frac{π d}{λ} NA )}^{2}$$

where d=2a, d being the diameter of the fibre core.

This amounts to writing:

$$M = \frac{{V}^{2}}{2}$$

The number of modes liable to propagate in a fibre grows very quickly with the fibre core diameter. Although numerous, as shown in FIG. 2, these modes have well known characteristics and are perfectly depicted by Laguerre-Gauss polynomials.

FIG. 2 shows the spatial distribution of the natural modes of an optical fibre. The y-axis 42 shows the gain, and the x-axis 43 shows the distance relative to the centre of the fibre.

The shape of the beam is resolved into high order modes 41 and a zero-order mode (or fundamental mode) 40.

The zero-order mode, represented in the figure by the curve 40, has a Gaussian shape and the intensity thereof decreases in the radial direction according to the following law:

$$I ( r ) = exp ( - \frac{{r}^{2}}{{w}^{2}} )$$

The size w of the zero-order mode, called “fundamental mode”, in the fibre is approximately given by the formula:

$$\frac{w}{a} = 0.650 + 1.619 {V}^{- 3 / 2} + 2.879 {V}^{- 6}$$

It is possible, based on theses expressions, to force the optical fibre to guide the fundamental mode. If the light intensity incident on the input of one of the faces 23, 24 of the optical fibre corresponds to a natural mode of propagation in this fibre, the energy stays confined in this mode and can not excite any higher order mode.

Thus, the light intensity profile at the output of the optical fibre is exactly equal to that of the injected mode.

The difficulty is thus to inject to one of the faces 23, 24 of the optical fibre a light intensity distribution exactly equal to that of the fundamental mode.

Only some amplitude and phase distributions of a wave can propagate through an optical submodule 25, 26 without being deformed, provided that the optical and geometrical characteristics of the optical submodule 25, 26 are compatible with a stable propagation in the sense of Gaussian optics. Thus, it is possible to find very particular distributions reproducing with minimum losses, or even without any diffraction loss, after a round trip in said optical submodule 25, 26. These distributions can be considered as natural modes of propagation of the optical submodule 25, 26, the fundamental mode having a Gaussian intensity distribution. When a light distribution (in amplitude and phase) corresponding to a natural mode of the optical submodule 25, 26 is placed on the input face of the optical submodule 25, 26, this distribution stay without any change or loss after a round trip in the optical submodule 25, 26.

Conversely, a wave whose characteristics do not correspond to the fundamental mode of the optical submodule 25, 26 will, on the one hand, undergo diffraction losses in the optical submodule 25, 26 and, on the other hand, the amplitude and phase distribution thereof will be fully transformed by the passage through the optical submodule 25, 26.

To solve the problem of mode filtering in a multimode fibre, each optical submodule 25, 26 is designed so that the fundamental mode thereof has, at the interface between the optical submodule 25, 26 and the multimode optical fibre 7, characteristics that are equal or almost equal to that of the fundamental mode of the multimode fibre 7. So, the optical submodules 25, 26 operate to reimage to itself the fundamental mode issuing from one of the input or output faces 23, 24 of the multimode optical fibre 7, so as to excite only or almost only the fundamental mode of the multimode optical fibre. The term “imaging” is here understood in the sense of Gaussian beams and not of light rays, which means that a beam reimaged on itself has, after a round trip in an optical system, an amplitude and phase distribution identical to that of the incident wave.

The optical submodule 25, 26 operates to adapt the size w of the fundamental mode of the laser beam incident on one of the input or output faces 23, 24 of the multimode optical fibre 7, so as to produce a single-mode or almost single-mode laser beam at the output of the other input or output face 23, 24 of the multimode optical fibre 7.

Indeed, each optical submodule 25, 26 is a spatial filtering means adapted to permit the energy of the laser beam incident on the input or output face 23, 24 to be spatially filtered, so as to reduce the gain of the high order modes below a gain threshold and to bring the fundamental mode gain above said gain threshold.

The gain threshold corresponds to the threshold that permits a laser effect to be obtained.

The filtering means implemented by the optical submodules 25, 26 are arranged opposite to the input and output faces 23, 24, respectively, of the multimode optical fibre 7.

The optical submodules 25, 26 are independent from the amplifying multimode optical fibre 7. The optical submodules 25, 26 will favour the fundamental mode and, consequently, impose a single-mode emission, even if the amplifying medium is able to support several modes.

Each optical submodule 25, 26 comprises optical means 2, 8 having a definite position in the optical submodule 25, 26 so as to make the optical submodule able to reproduce, after a round trip of the laser beam in this latter, the amplitude and phase of the fundamental mode of the multimode optical fibre 7 to the input or output face 23, 24 of said multimode optical fibre 7, whereby minimising diffraction losses in the fundamental mode.

The position of the optical means 2, 8 is also defined in the optical submodule 25, 26 so as to make the optical submodule able to filter the other modes, producing additional diffraction losses in said other modes, whereby minimising the number of laser modes that propagate in the optical resonator.

It is preferably attempted to reproduce the fundamental mode of the multimode optical fibre 7 and to minimize the diffraction losses in this mode.

Even if the optical submodules 25, 26 do not filter all of the non-fundamental modes, the number of modes of the laser beam at the output of the optical resonator 12 is very distinctly lower that the number of intrinsic modes of the multimode optical fibre 7.

In the embodiment shown in FIG. 3, the first optical submodule 25 comprises optical means 2, 8 consisting of a lens 2a or several lenses and a mirror 6, positioned so that the characteristics of the fundamental mode of this optical submodule 25 correspond to the fundamental mode of the multimode optical fibre 7 on the input face 23.

The second optical submodule 26 also comprises optical means 2, 8 consisting of a lens 8a or several lenses and a partially reflective mirror 9, positioned so that the characteristics of the fundamental mode of this optical submodule 26 correspond to the fundamental mode of the multimode optical fibre 7 on the output face 24.

The optical means 2, 8 of a submodule 25, 26 can comprise the input or output face 23, 24 of the multimode optical fibre 7. The input or output face 23, 24 can be filtering itself or can have an optical power taking part in the optical submodule 25, 26.

The input or output face 23, 24 of the multimode optical fibre 7 is then worked by cleaving, melting, polishing or any other optical making technique, and allows a non-zero convergence to be obtained.

The operating mode of the power fibre laser device will now be described in details.

The power laser diode 1 generates a pump wave which is injected into the multimode optical fibre 7 through a lens 11 focusing the pump wave to a dichroic mirror 3. The wave pump is then focused to the input face 23 of the multimode optical fibre 7 by the lens 2a of the optical means 2 of the first optical submodule 25. The radiation of the power laser diode 1 is absorbed in the core 20 of the multimode optical fibre 7.

The multimode optical fibre 7 then emits a second radiation at a wavelength λ which is guided all along the multimode optical fibre 7, up to the output face 24 of the multimode optical fibre 7. This radiation is then collimated by the lens 8a of the optical means 8 of the second optical submodule 26, before being incident on the partially reflective mirror 9 at the wavelength λ.

Thus, a part of the radiation is returned into the multimode optical fibre 7. At the output of the input face 23 of the multimode optical fibre 7, the radiation is collimated to the dichroic mirror 3, by the lens 2a of the optical means 2, 8 of the first optical submodule 25.

The fully reflective end 6 consisting of a fully reflective mirror closes the optical resonator 12 and returns the radiation to itself towards the multimode optical fibre 7. This mirror can be planar or curved.

The filtering principle of the mode resonating in this fibre laser is to match the geometrical characteristics of the two optical submodules 25, 26.

To that end, the distances, focal lengths and curvature radiuses of the different optical elements are adjusted so that the neck region of the Gaussian beam that can resonate in the optical submodules 25, 26 correspond exactly to that of the fundamental mode in the amplifying multimode optical fibre 7.

The natural mode of the first optical submodule 25 is obtained, for example, with the ABCD matrixes method (“Laser”, Siegmann). As the input face 13 of the fibre 7 is planar, the Gaussian beam necessarily presents a neck region at this place. This method can be used to calculate the size of the natural mode, i.e. the mode being reimaged on itself in amplitude and phase, after a round trip in the first optical submodule 25, and having automatically a neck region at this same place.

It is to be noted that this calculation uses Gaussian beams and thus is not equivalent to a calculation of geometric optics. Here, there is no imaging in the geometrical sense of the term, but propagation of a Gaussian mode, i.e. of an energy distribution and a phase edge.

The same method can be applied to calculate the mode of the second optical submodule 26.

This method thus permits to adjust the parameters of the two optical submodules 25, 26 so that the size w of the mode of each of the optical submodules 25, 26 corresponds exactly or almost exactly to the size of the fundamental mode of the multimode optical fibre 7 on the input face 23 and output face 24.

In these conditions, there is a resonance between the natural modes of the two optical submodules 25, 26 and of the multimode optical fibre 7. We are then in the conditions of minimal diffraction losses as well in the multimode optical fibre 7 as in the optical submodules 25, 26. The so-formed laser will naturally lase in this fundamental mode, even if the optical fibre can support other modes.

FIG. 4 shows the distances between the optical elements of the second optical submodule 26 that must be taken into account for the calculation.

The distance L1 corresponds to the distance between the output face of the multimode optical fibre 7 and the lens 8a of the optical means 8 of the second optical submodule 26.

The distance L2 corresponds to the distance between the lens 8a of the optical means 8 of the second optical submodule 26 and the partially reflective mirror 9.

The above-mentioned method allows the distances L1 and L2 to be calculated so that the fundamental mode has the size w at the output face 24. In this example, the focal length of the lens 8a of the optical means 8 of the second optical submodule 26 is f2=8 mm.

FIG. 5 shows couples L1-L2 for which the second submodule 26 resonates in the fundamental mode, for different size (or mode diameter) values w.

FIG. 5 shows that, for each value of w herein comprised between 15 and 25 micrometers, a couple L1-L2 exists for which the second optical submodule 26 resonates in this mode.

The same calculation can be made for the first optical submodule 25, to tune this first optical submodule 25 to the fundamental mode of the fibre.

In this embodiment, the multimode optical fibre 7 is a double-sheath fibre doped with Ytterbium-ions. The size values thereof are the following:

Diameter of the core: 50 μm;

Diameter of the pumping sheath: 200 μm;

Numerical aperture of the core: 0.06;

This multimode optical fibre 7 has a fundamental mode of about 18 μm, with a radius of 1/e².

When the first 25 and the second 26 optical submodules are not tuned, the laser device according to FIG. 3 emits a spatially multimode radiation.

When the first 25 and the second 26 optical submodules are so constructed that the fundamental mode thereof corresponds to that of the optical fibre 7, a spatial single-mode beam is obtained at the output of the laser device.

Several sets of parameters give the above-mentioned result. The curvature radiuses of the fully reflective 6 and partially reflective 9 mirrors can be adapted, provided that the distances between the optical elements of the resonator 12 are concomitantly varied.

The fully reflective 6 and partially reflective 9 mirrors can be curved or planar. In a preferred embodiment, the fully reflective mirror 6 has a curvature radius comprised between 100 and 200 mm, the lens 2a of the optical means 2 of the first optical submodule 25 is aspherical with a focal length of 8 mm, the lens 8a of the optical means 8 of the second optical submodule 26 is aspherical with a focal length of 8 mm, and the partially reflective mirror 9 is planar.

The partially reflective mirror 9 can be chosen among the following elements:
Partially reflective mirror with a reflectivity comprised between 4% and 50%;
Planar or curved glass plate;
Diffraction grating with a reflectivity comprised between 4% and 50%
Massive Brag grating with a reflectivity comprised between 4% and 50%.

In a preferred embodiment, the partially reflective mirror 9 is positioned so as the pump beam issuing from the pumping sheath is precisely returned on itself. This position is optimized through a geometric optic calculation so that the output face 24 of the fibre is imaged on itself after being reflected on the partially reflective mirror 9, with a magnification equal to 1 or −1 and an image numerical aperture equal to the object numerical aperture.

In another embodiment, the optical resonator 12 comprises a lens 4 disposed between the dichroic mirror 3 and the fully reflective end 6.

The distances between the optical elements are then recalculated to take this lens 4 into account.

FIG. 6 shows another embodiment in which the optical resonator 12 comprises only the first optical submodule 25. This first optical submodule 25 comprises optical means 2 consisting of a lens 2a and a fully reflective mirror 6.

The optical resonator 12 is closed at the other end thereof by an optical closure means.

The optical closure means closing the optical resonator 12 has both convergence and reflection properties for a light wave.

It can consist of a single optical element having both convergence and reflection properties for a light wave.

The optical closure means closing the optical resonator 12 can be the output face 24 of the multimode optical fibre.

The output face 24 of the multimode optical fibre must have an almost-perfect planarity as well as an almost-perfect perpendicularity relative to the axis of the latter so as to fulfill the conditions for the fundamental mode issuing from the core of the fibre to be reimaged on itself. If the other side of the optical resonator 12 comprises a first optical submodule 25 tuned to the natural mode of the fibre, the fundamental mode alone will be able to resonate without loss.

The output face 24 can present a curvature, provided that the distance between this output face ant the input of the guiding region in the optical fibre 7 and the curvature of the face is chosen so as to fulfill the conditions for the fundamental mode issuing from the core of the fibre to be reimaged on itself.

The spatial filtering used in the optical resonator 12 can also use any system permitting discrimination of radiations of different divergences.

It is also possible to realize an embodiment in which the optical resonator 12 comprises only the second optical submodule 26. This second optical submodule 26 comprises an optical mean 8 consisting of a lens 8a and a partially reflective mirror 9. The optical closure means closing the optical resonator 12 consists of the input face 23 of the multimode optical fibre 7.

The fully reflective end 6 consists of the input face 23 of the multimode optical fibre 7.

According to another embodiment, shown in FIG. 7, the optical means 2, 8 of the two sub-cavities 25, 26 each comprises a single-mode fibre tip 36 in contact with one of the input and output faces 23, 24 of the multimode optical fibre 7. The laser beam is focused on the single-mode fibre tips 36 by lenses 2b, 8b.

The single-mode fibre tip 36 has a core diameter close to that of the multimode optical fibre 7.

The optical resonator 12 advantageously comprises two single-mode fibre tips 36. A first single-mode fibre tip 36 is arranged in contact with the input face 23 of the multimode optical fibre 7 and a second single-mode fibre tip 36 is arranged in contact with the output face 24 of the multimode optical fibre 7. These single-mode fibre tips 36 can be made from a microstructured fibre.

So, an integrated structure is made, in which filtering of the modes is performed thanks to association of one or more single-mode fibre tips 36 with an amplifying multimode optical fibre 7. In this case, the characteristics of the multimode 7 and single-mode 36 optical fibres forming the different sections are calculated so that the fundamental modes thereof match together and that a resonance exists between the fundamental mode of the single-mode fibre tips 36 and the fundamental mode of the multimode optical fibre 7. As the single-mode fibre tips 36 are not doped with lasing ions, they are very easier to make.

In an embodiment, the single-mode fibre tip(s) 36 can be single-mode photonic fibres and the amplifying multimode optical fibre 7 can be a doped fibre (photonic or not).

The single-mode fibre tips 36 are, for example, welded on the doped amplifying multimode optical fibre 7 or associated with the fibre by fusion, bonding or deposition.

The single-mode fibre tip 36 contains a so-called “double-clad” structure, comprising, one the one hand, a single-mode core 20 and, on the other hand, a pump sheath 21 having characteristics (diameter and numerical aperture) equivalent to the doped multimode optical fibre 7 used as an amplifier.

The optical resonator 12 is closed by the fully reflective end 6 which can be a spherical mirror, the curvature radius and position of which are calculated so as to ensure that the fundamental mode issuing from the single-mode fibre tip 36 in contact with the first end 23 is imaged without any size or numerical aperture changing on the face of this first end 23 after being reflected on the spherical mirror 6.

The spatial mode filtering can be performed by any element, the transmission or the reflection of which strongly depends on the incidence on this element, and in particular a volume Bragg mirror.

Filtering can also be obtained through a particular treatment of the mirror(s) of the optical resonator 12.

In an embodiment shown in FIG. 8, the optical resonator 12 can comprise an optical trigger 10 arranged close to the fully reflective end 6. It enables the optical resonator 12 to generate giant light pulses from a pumping source emitting a continuous radiation.

Preferably, the trigger 10 is arranged between the fully reflective end 6 and the dichroic mirror 3.

The trigger 10 enables nanosecond pulses to be generated.

For a stable operation to be ensured, it is necessary that the rest of the optical resonator 12 does not couple a part of the energy of the fundamental mode to the other modes.

To this end, the multimode optical fibre 7 is mechanically stiffened by a stabilizing means that stabilizes the curvature radius of the multimode optical fibre 7 so as to reduce coupling of the fundamental mode with the higher order modes.

According to an embodiment of the invention, the stabilizing means of the multimode optical fibre 7 consists of a large-diameter mechanical sheath 13 (of the stiff rod type) surrounding said multimode optical fibre 7, so as to stiffen the multimode optical fibre 7. It is known to use such mechanical sheath 13, shown in FIG. 9, for a single-mode optical fibre.

FIG. 9 shows a cross-section of a multimode optical fibre 7 comprising a core 20 surrounded by a pumping sheath 21, itself surrounded by a confining sheath 22, which is surrounded by a mechanical sheath 13, which can be made of glass.

According to another embodiment, shown in FIG. 10, the stabilizing means of the multimode optical fibre 7 comprises a cylindrical support 14 in the periphery 17 of which is hollowed-out a groove 16. The groove 16 is hollowed out around the cylindrical support 14 in a helical manner. The multimode optical fibre 7 is inserted in this groove 16 so as to be tension- or pressure-locked.

The cylindrical support 14 comprises two input 28 and output 29 supports through which the multimode optical fibre 7 go into and out of the cylindrical support 14. The lenses 2a, 8a of the optical means 2, 8 of the optical submodules 25, 26 can be arranged in front of these two input 28 and output 29 supports and in front of the input face 23 and of the output face 24 of the multimode optical fibre 7. These two input 28 and output 29 supports comprise a groove similar to that of the cylindrical support 14, for the multimode optical fibre 7 to be inserted thereto.

In this embodiment, the multimode optical fibre 7 is preferably flexible.

According to another embodiment of the invention, shown in FIG. 11, the stabilizing means of the multimode optical fibre 7 comprises a linear support 15 having a hollowed-out groove in which the multimode optical fibre 7 is inserted along a longitudinal axis 19. A second piece 33 covers the multimode optical fibre 7 so as to pressure-lock the latter.

So as to favour a rectilinear polarization, it is preferable for the fibre to be stiffened while being maintained in a plane.

In these two examples, the grooves are machined in a solid and, if possible, good heat-conductive material, so as to minimize the thermal effects on the multimode optical fibre 7. It is important that the whole multimode optical fibre 7 is in contact with the stiff support 14, 15.

In these two examples, the size of the groove 16 is adapted for the multimode optical fibre 7 to be inserted therein.

In any case, it is necessary to ensure that the curvature radius of the multimode optical fibre 7 does not introduce coupling between the spatial modes.

In this embodiment, the multimode optical fibre 7 is semi-stiffen or flexible, and the curvature radius thereof can go up to the infinite.

In a conventional fibre laser, the micro- or macro-curvatures of the fibre introduce couplings between the polarization states. Thus, it is difficult to maintain a stable polarization state with a flexible fibre, a fortiori if it is multimode. The stabilizing means according to the invention allows maintaining a stable polarization state for the fibre.

In another embodiment, it is possible to introduce in the optical resonator 12 an acousto-optical or electro-optical triggering element, to enable a gain or a loss varying according to the polarization state. It is possible to have a polarized radiation, even if the multimode amplifying medium is not of the polarization conservation type. It is also possible to obtain a continuous radiation or a polarized pulsed radiation.

The invention also relates to a power fibre laser system comprising a power fibre laser device as above-described and a double-sheath amplifying multimode optical fibre.

The light signal transmitted through the partially reflective end 9 of the optical resonator 12 is coupled to one of the faces of the amplifying multimode optical fibre, so as to match the size of the fundamental mode of the transmitted laser beam with the size of the face of the amplifying multimode optical fibre. A maximum part of the stimulated radiation excited by the pump wave is coupled to the fundamental mode.

As above-mentioned, in an index-step or index-gradient optical fibre, the diameter equal to 1/e2 is substantially smaller than the diameter of the doped core (36 micrometers in a fibre of 50 micrometers in the shown case). The index-step fibre, the core of which is fully doped, is not the fibre the best fitted for pump energy coupling in the fundamental mode. Thus, in a particular embodiment, it is possible to optimize the laser device with an optical fibre, the guiding core of which has a non-uniform doping profile in the transverse direction. This offers the double advantage of favouring the pump-fundamental mode coupling and thus the laser yielding, and of making the above-mentioned mode filtering easier.

This type of coupling is also possible with an optical fibre having a variable index in all or part of the guiding core.

So, the power fibre laser device operates to produce with a very good yield a stable single-mode radiation in the fundamental mode from a multimode fibre having an arbitrarily large diameter, without risk for the fibre longevity.

1. A power fibre laser device comprising:
a power laser diode (1) emitting a pump wave,
an optical resonator (12) comprising:
a fully reflective end (6) and a partially reflective end (9),
an amplifying multimode optical fibre (7) having a core with a diameter greater than 20 μm, as well as an input face (23) and an output face (24) at the ends thereof,
at least one optical submodule (25, 26), said optical submodule (25, 26) being formed between the input face (23) of the multimode optical fibre and the fully reflective end (6) or between the output face (24) of the multimode optical fibre and the partially reflective end (9),
optical coupling means (3, 11, 2) that couple said pump wave in the multimode optical fibre (7) so as to produce a laser beam in the optical resonator (12), a part of said laser beam being transmitted outside the optical resonator (12) through the partially reflective end (9) and another part of said laser beam being reflected inside the optical resonator (12),
characterized in that:
the optical submodule (25, 26) is a spatial filtering means comprising optical means (2, 8) having a definite position in the optical submodule (25, 26) so as to make the optical submodule able to reproduce, after a round trip of the laser beam in this latter, the amplitude and phase of the fundamental mode of the multimode optical fibre (7) onto the input or output face (23, 24) of said multimode optical fibre (7), whereby minimising losses in the fundamental mode, and so as to make the optical submodule able to filter the other modes, producing additional losses in said other modes in the optical resonator, whereby minimising the number of laser modes that propagate in the optical resonator.

2. The power fibre laser device according to claim 1, characterized in that the optical resonator (12) comprises two submodules (25, 26), arranged at each end of the multimode optical fibre (7).

3. The power fibre laser device according to claim 1, characterized in that the optical resonator (12) comprises only one optical submodule (25, 26), arranged at one end of the multimode optical fibre (7), the optical resonator (12) being closed at the other end thereof by an optical closure means.

4. The power fibre laser device according to claim 3, characterized in that the optical closure means closing the optical resonator (12) consists of one of the input or output faces (23, 24) of the multimode optical fibre, said input or output face (23, 24) being planar and perpendicular to the optical axis of the optical fibre (7).

5. The power fibre laser device according to claim 3, characterized in that the optical closure means closing the optical resonator (12) consists of a single optical element having both convergence and reflection properties for a light wave.

6. The power fibre laser device according to claim 1, characterized in that the optical means (2, 8) of an optical submodule (25, 26) comprise one or more lenses (2a, 2b) associated with one of the reflective ends (6, 9).

7. The power fibre laser device according to claim 1, characterized in that the optical means (2, 8) of an optical submodule (25, 26) comprise the input or output face (23, 24) of the multimode optical fibre (7), said input or output face (23, 24) having an inherent convergence that takes part in the filtering function.

8. The power fibre laser device according to claim 6, characterized in that the optical means (25, 26) of an optical submodule (25, 26) comprise a single-mode fibre tip (36) in contact with one of the input and output faces (23, 24) of the multimode optical fibre (7), the laser beam being focused on said single-mode fibre tip (36) by a lens (2b, 8b).

9. The power fibre laser device according to claim 1, characterized in that the core of the multimode optical fibre (7) has a non-uniform radial doping profile so as to favour the gain of the fundamental mode.

10. The power fibre laser device according to claim 1, characterized in that the multimode optical fibre comprises inherent filtering means so as to be slightly multimode.

11. The power fibre laser device according to claim 1, characterized in that the multimode optical fibre (7) is mechanically stiffened by a stabilizing means.

12. The power fibre laser device according to claim 11, characterized in that the stabilizing means of the multimode optical fibre (7) consists of a large-diameter mechanical sheath (13) surrounding said multimode optical fibre (7).

13. The power fibre laser device according to claim 11, characterized in that the stabilizing means of the multimode optical fibre (7) consists of a cylindrical support (14), in the periphery (17) of which is hollowed-out a groove (16), in an helical manner, said multimode optical fibre (7) being inserted in said groove (16) so as to be tension-locked.

14. The power fibre laser device according to claim 11, characterized in that the stabilizing means of the multimode optical fibre (7) consists of a linear support (15) having a hollowed-out groove (34) in which the multimode optical fibre (7) is inserted along a longitudinal axis (19), said multimode optical fibre (7) being covered with a second piece (33) so as to be pressure-locked.

15. The power fibre laser device according to claim 1, characterized in that the optical resonator (12) comprises an optical trigger (10) arranged close to one of the reflective ends (6, 9), enabling the optical resonator (12) to generates laser pulses.

16. The power fibre laser device according to claim 1, characterized in that it comprises one or more polarizing optical means.

17. A power fibre laser system, characterized in that it comprises a power fibre laser device as defined according to claim 1, and a double-sheath amplifying multimode optical fibre, the light signal transmitted by the partially reflective end (9) of the optical resonator (12) being coupled to one of the faces of the amplifying multimode optical fibre, so as to excite the fundamental mode of the double-sheath amplifying multimode optical fibre.

18. The power fibre laser device according to claim 2, characterized in that the optical means (2, 8) of an optical submodule (25, 26) comprise one or more lenses (2a, 2b) associated with one of the reflective ends (6, 9).

19. The power fibre laser device according to claim 3, characterized in that the optical means (2, 8) of an optical submodule (25, 26) comprise one or more lenses (2a, 2b) associated with one of the reflective ends (6, 9).

20. The power fibre laser device according to claim 4, characterized in that the optical means (2, 8) of an optical submodule (25, 26) comprise one or more lenses (2a, 2b) associated with one of the reflective ends (6, 9).
